(19) United States
(12) Patent Application Publication
(10) Pub. No.: US 2005/0115220 A1
(43) Pub. Date: Jun. 2, 2005

(54) Hydraulic rocket

(76) Inventor: Shanker Mo, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/726,187

(22) Filed: Dec. 1, 2003

(51) Int. Cl. F02K 7/00

(52) U.S. Cl. 60/221

(57) ABSTRACT

A hydraulic rocket includes a main body having a first end, a cylindrical mediate section and a tapered second end, a warhead mounted on the first end of the main body, a rear skirt mounted on the second end of the main body, and a nozzle mounted on the second end of the main body and rested on the rear skirt to position the rear skirt on the second end of the main body. Thus, the rear skirt and the warhead are directly mounted on the main body without needing to provide any bonding agent, so that the hydraulic rocket can be assembled easily and conveniently, thereby facilitating the user assembling the hydraulic rocket.

### BACKGROUND OF THE INVENTION

1. Field of the Invention

The present invention relates to a hydraulic rocket, and more particularly to a hydraulic rocket that can be assembled easily and conveniently without needing to provide any bonding agent.

2. Description of the Related Art

A conventional hydraulic rocket in accordance with the prior art shown in FIG. 5 comprises a main body 1, a warhead 2 mounted on a front end 11 of the main body 14 a socket 3 mounted on a rear end 12 of the main body 1, a plurality of stabilizing fins 32 bonded on the socket 3 by bonding agent, and a connecting member 13 mounted on a distal end of the rear end 12 of the main body 1 for connected to an ejector (not shown). Thus, the main body 1 is ejected by the ejector.

However, the stabilizing fins 32 are bonded on the socket 3 by bonding agent, thereby consuming a great deal of time and manual work. In addition, the socket 3 is mounted on the main body 1, so that the socket 3 has a diameter greater than that of the main body 1, thereby increasing the air drag during movement of the hydraulic rocket. Further, the stabilizing fins 32 are bonded on the socket 3 by a manual work, so that the angles of the stabilizing fins 32 are easily deflected, thereby affecting movement of the hydraulic rocket. Further, the stabilizing fins 32 are bonded on the socket 3, so that the angles of the stabilizing fins 32 are easily broken or worn out during a long-term utilization.

### SUMMARY OF THE INVENTION

The primary objective of the present invention is to provide a hydraulic rocket that can be assembled easily and conveniently without needing to provide any bonding agent.

Another objective of the present invention is to provide a hydraulic rocket, wherein the rear skirt and the warhead are directly mounted on the main body without needing to provide any bonding agent, so that the hydraulic rocket can be assembled easily and conveniently, thereby facilitating the user assembling the hydraulic rocket.

A further objective of the present invention is to provide a hydraulic rocket, wherein each of the tapered reinforcement ribs of the rear skirt is closely rested on the resting flange of the main body, so that the rear skirt is closely rested on the second end of the main body without vibration.

A further objective of the present invention is to provide a hydraulic rocket, wherein the outer wall of the rear skirt is equal to or smaller than the diameter of the mediate section of the main body to reduce the air drag during movement of the hydraulic rocket.

In accordance with the present invention, there is provided a hydraulic rocket, comprising:
a main body having a first end, a cylindrical mediate section and a tapered second end;
a warhead mounted on the first end of the main body;
a rear skirt mounted on the second end of the main body; and
a nozzle mounted on the second end of the main body and rested on the rear skirt to position the rear skirt on the second end of the main body.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hydraulic rocket in accordance with the preferred embodiment of the present invention;

FIG. 2 is an exploded perspective view of the hydraulic rocket in accordance with the preferred embodiment of the present invention;

FIG. 3 is a plan cross-sectional view o the hydraulic rocket as shown in FIG. 1;

FIG. 4 is a plan cross-sectional view of the hydraulic rocket as shown in FIG. 1; and

FIG. 5 is a plan cross-sectional view of a conventional hydraulic rocket in accordance with the prior art.

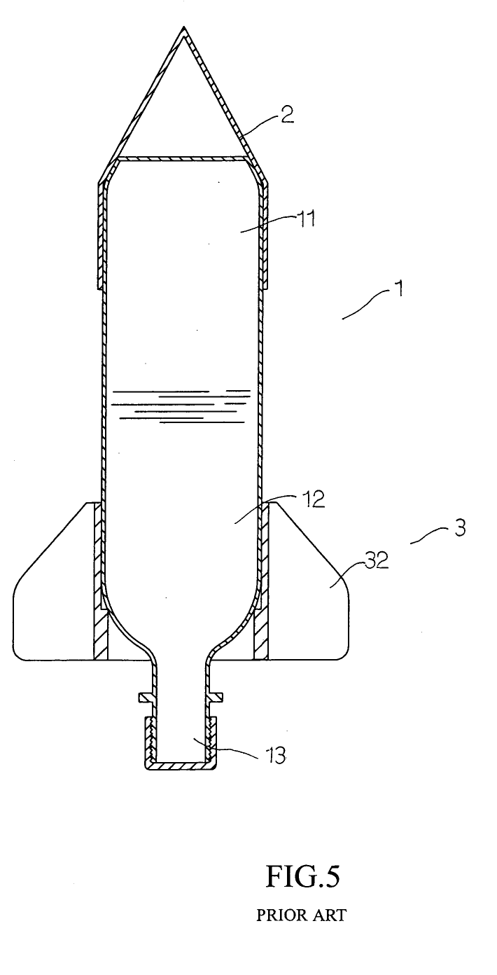

### DETAILED DESCRIPTION OF THE INVENTION

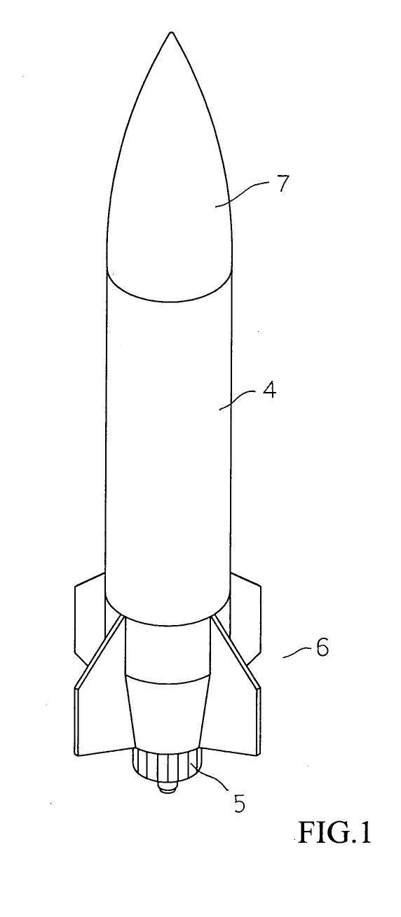

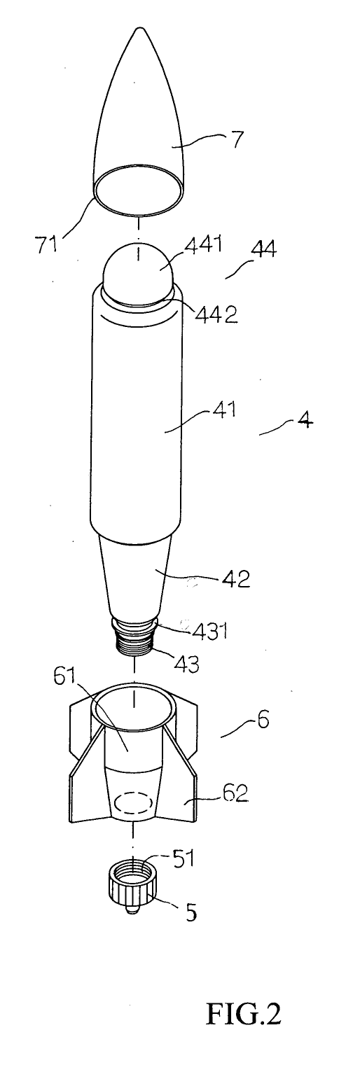

Referring to the drawings and initially to FIGS. 1-3, a hydraulic rocket in accordance with the preferred embodiment of the present invention comprises a main body 4, a warhead 7, a rear skirt 6, and a nozzle 5.

The main body 4 is made of elastic plastic material. The main body 4 has a first end 44, a cylindrical mediate section 41 and a tapered second end 42. The first end 44 of the main body 4 is formed with a semi-spherical connecting portion 441 having a periphery formed with an annular locking groove 442. The second end 42 of the main body 4 has a distal end formed with a threaded connector 43. The threaded connector 43 of the main body 4 has a periphery formed with an annular resting flange 431.

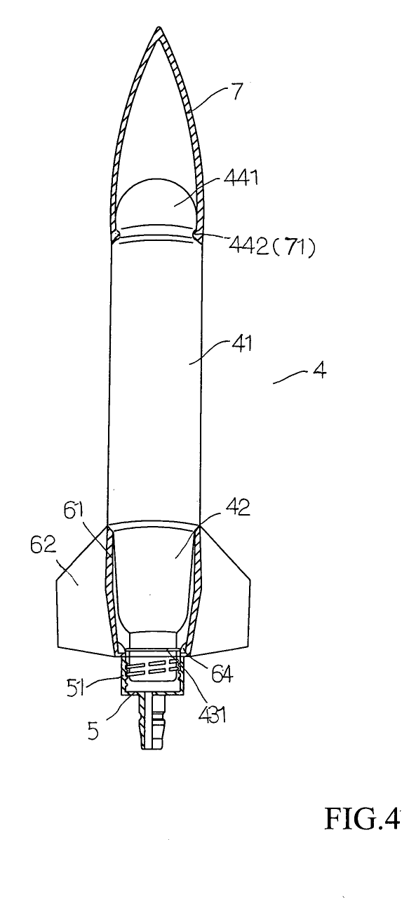

As shown in FIGS. 1 and 4, the warhead 7 is mounted on the first end 44 of the main body 4 and has an inner wall formed with an annular locking flange 71 locked in the locking groove 442 of the main body 4. Preferably, the warhead 7 is forced onto the elastic connecting portion 441 of the main body 4 in a close fit manner.

The rear skirt 6 is a hollow barrel mounted on the second end 42 of the main body 4. The rear skirt 6 has a tapered inner wall to mate with the tapered second end 42 of the main body 4 so that the rear skirt 6 is closely rested on the second end 42 of the main body 4. The rear skirt 6 has an outer wall 61 integrally formed with a plurality of stabilizing fins 62. The outer wall 61 of the rear skirt 6 has a diameter equal to or smaller than that of the mediate section 41 of the main body 4 to reduce the air drag during movement of the hydraulic rocket.

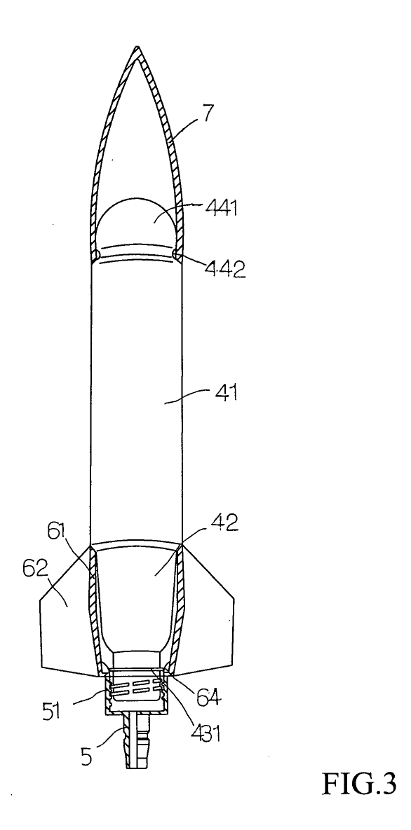

The inner wall of the rear skirt 6 is formed with a plurality of reinforcement ribs 64 (FIG. 3) rested on the resting flange 431 of the main body 4. Preferably, each of the reinforcement ribs 64 of the rear skirt 6 has an arcuate tapered shape. In addition, each of the tapered reinforcement ribs 64 of the rear skirt 6 has a maximum diameter greater than the diameter of the resting flange 431 of the main body 4 and has a minimum diameter smaller than the diameter of the resting flange 431 of the main body 4, so that each of the tapered reinforcement ribs 64 of the rear skirt 6 is closely rested on the resting flange 431 of the main body 4. Thus, the rear skirt 6 is closely rested on the second end 42 of the main body 4 without vibration.

The nozzle 5 is mounted on the second end 42 of the main body 4 and is rested on the rear skirt 6 to position the rear skirt 6 on the second end 42 of the main body 4. The nozzle 5 has an inner wall formed with an inner thread 51 screwed on the threaded connector 43 of the main body 4, so that the nozzle 5 is secured on the threaded connector 43 of the main body 4.

Accordingly, the rear skirt 6 and the warhead 7 are directly mounted on the main body 4 without needing to provide any bonding agent, so that the hydraulic rocket can be assembled easily and conveniently, thereby facilitating the user assembling the hydraulic rocket. In addition, each of the tapered reinforcement ribs 64 of the rear skirt 6 is closely rested on the resting flange 431 of the main body 4, so that the rear skirt 6 is closely rested on the second end 42 of the main body 4 without vibration. Further, the outer wall 61 of the rear skirt 6 is equal to or smaller than the diameter of the mediate section 41 of the main body 4 to reduce the air drag during movement of the hydraulic rocket.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hydraulic rocket, comprising:
a main body having a first end, a cylindrical mediate section and a tapered second end;
a warhead mounted on the first end of the main body;
a rear skirt mounted on the second end of the main body; and
a nozzle mounted on the second end of the main body and rested on the rear skirt to position the rear skirt on the second end of the main body.

2. The hydraulic rocket in accordance with claim 1, wherein the main body is made of elastic plastic material.

3. The hydraulic rocket in accordance with claim 1, wherein the second end 42 of the main body 4 has a distal end formed with a threaded connector having a periphery formed with an annular resting flange, and the rear skirt has an inner wall formed with a plurality of reinforcement ribs rested on the resting flange of the main body.

4. The hydraulic rocket in accordance with claim 3, wherein the nozzle has an inner wall formed with an inner thread screwed on the threaded connector of the main body, so that the nozzle is secured on the threaded connector of the main body.

5. The hydraulic rocket in accordance with claim 3, wherein each of the reinforcement ribs 64 of the rear skirt 6 has an arcuate tapered shape.

6. The hydraulic rocket in accordance with claim 5, wherein each of the tapered reinforcement ribs 64 of the rear skirt 6 has a maximum diameter greater than the diameter of the resting flange 431 of the main body 4 and has a minimum diameter smaller than the diameter of the resting flange 431 of the main body 4, so that each of the tapered reinforcement ribs 64 of the rear skirt 6 is closely rested on the resting flange 431 of the main body 4.

7. The hydraulic rocket in accordance with claim 1, wherein the first end of the main body is formed with a connecting portion having a periphery formed with an annular locking groove, and the warhead has an inner wall formed with an annular locking flange locked in the locking groove of the main body.

8. The hydraulic rocket in accordance with claim 7, wherein the connecting portion of the main body has a substantially semi-spherical shape.

9. The hydraulic rocket in accordance with claim 7, wherein the warhead is forced onto the connecting portion of the main body in a close fit manner.

10. The hydraulic rocket in accordance with claim 1, wherein the rear skirt is a hollow barrel.

11. The hydraulic rocket in accordance with claim 1, wherein the rear skirt has a tapered inner wall to mate with the tapered second end of the main body so that the rear skirt is closely rested on the second end of the main body.

12. The hydraulic rocket in accordance with claim 1, wherein the rear skirt has an outer wall integrally formed with a plurality of stabilizing fins.

13. The hydraulic rocket in accordance with claim 1, wherein the rear skirt has an outer wall having a diameter equal to that of the mediate section of the main body.

14. The hydraulic rocket in accordance with claim 1, wherein the rear skirt has an outer wall having a diameter smaller than that of the mediate section of the main body.
